(19) United States
(12) Patent Application Publication
(10) Pub. No.: US 2020/0114490 A1
(43) Pub. Date: Apr. 16, 2020

(54) Protective Device for a Hand-Held Power Tool

(71) Applicant: Robert Bosch GmbH, Stuttgart (DE)

(72) Inventors: Sinisa Andrasic, Schoenaich (DE); Jakob Meier, Stuttgart (DE); Marcus Schuller, Dettenhausen (DE)

(21) Appl. No.: 16/626,713

(22) PCT Filed: Jul. 26, 2018
(86) PCT No.: PCT/EP2018/070329

§ 371 Date: Dec. 26, 2019

(30) Foreign Application Priority Data
Aug. 8, 2017 (DE) 10 2017 213 746.0

(51) Int. Cl. B24B 55/05

(52) U.S. Cl. CPC B24B 55/052; B23Q 11/06

(57) ABSTRACT

A protective device for a hand-held power tool, in particular an angle grinder, includes a machine housing, a protective hood, and a securing element. The machine housing has a flange neck that surrounds an output shaft that defines an output axis. The protective hood has a protective hood collar. The securing element is formed as a securing ring that is configured, in at least one operating state, to prevent the protective hood from twisting relative to the machine housing. The machine housing is configured to be detachably connected to one or more of the protective hood and the securing element. The securing ring has a thread, in particular an internal thread, which in at least one connection state is configured to movably mount and hold the protective hood in an axial direction of the output axis relative to the flange neck.

The invention relates to a protective device according to the preamble of the first claim.

### PRIOR ART

In DE 10 2008 040 369 A1 is a protective-hood rotation locking device for an angle grinder, which is designed for rotation locking between the hand-held power tool and a protective hood unit, having a clamping band, which comprises a rotation locking region having a positive-engagement profile. The protective-hood rotation locking device has a flow-of-force element, which is designed to reduce a density of a flow of force with respect to a pure positive-engagement profile, in at least one part of the rotation locking region.

### Disclosure of the Invention

The invention is based on the object of improving, by simple structural design measures, a protective device for a hand-held power tool, in particular an angle grinder.

The object is achieved by a protective device for a hand-held power tool, in particular an angle grinder, comprising a machine housing that has a flange neck surrounding an output shaft having an output axis, comprising a protective hood, which in particular has a protective hood collar, and comprising a securing element realized as a securing ring, which is designed, in at least one operating state, to form a means for locking the protective hood against rotation with respect to the machine housing, wherein the machine housing can be detachably connected to the protective hood and/or the securing element.

According to the invention, the securing ring has a thread, in particular an internal thread, that is designed, in at least one connection state, to mount and hold the protective hood such that it is movable, with respect to the flange neck, in the axial direction of the output axis.

The thread of the securing ring may be realized, in particular, so as to be continuous around the output axis. The thread of the securing ring may form a screwed connection with the protective hood.

The securing ring is designed, in at least one connection state, to limit an axial movement of the flange neck along the output axis and to enable a rotational movement in the circumferential direction, about the output axis.

The protective hood is intended, expediently, to cover at least or up to 180° of a cutting or grinding disk, and in order to protect the operator of the hand-held power tool from flying sparks. Depending on the use of the hand-held power tool, it is necessary to adjust the protective hood and accordingly bring it into different positions in order to cover typical application situations, such as left/right-handed users, cutting or grinding, profile of the material on which work is to be performed.

Owing to the threaded securing ring, the hand-held power tool can be of a particularly compact design, making it possible to achieve an optimum cutting depth, which is usually limited by the guard, as conventional guards protrude radially with respect to the output shaft.

In addition, the protective device according to the invention reduces a time-consuming adjustment, or rotational adjustment, of the protective hood, since the protective device according to the invention has a particularly simple receiving or connecting mechanism and fulfils the applicable legal requirements most satisfactorily, even under extreme conditions such as, for example, in the case of shattering of an insert tool.

The invention is described in the following principally using the example of a, in particular, hand-held power tool, which can be connected to an insert tool coupled to move rotatably about the output axis. The insert tool in this case may have a tool axis. The insert tool may be detachably connected to the output shaft in such a manner that, in particular, the tool axis and the output axis substantially coincide.

The machine housing is intended, in particular, to form a housing part of the hand-held power tool. In particular, the machine housing may have a transmission housing. The hand-held power tool is to be realized, preferably, as an angle grinder. The protective hood and the securing element may preferably be detachably connectable to the hand-held power tool by means of a screw connection, and can therefore also be separated from the hand-held power tool if necessary, for example in order to pack or compactly store the latter.

“Designed” in this context is to be understood to mean, in particular, specially configured and/or specially equipped.

In particular, on the basis of the example of an angle grinder, the protective device is realized with a protective hood that surrounds the output shaft. The protective hood in this case can be adjusted relative to the machine housing, in the circumferential direction around the output axis. The protective hood can block adjustability in the circumferential direction around the output axis, while protecting an operator against injury, for example in the case of a shattering insert tool, with rotation of the protective hood being blocked by shattering insert tool parts.

To ensure protection, the protective hood is to be arranged on the machine housing of the hand-held power tool and held reliably on the machine housing when the hand-held power tool is in operation. If necessary, the protective hood is to be detachable without use of tools and in a convenient manner, and/or radially adjustable.

Rotation locking is to be understood to mean, in particular, blocking of a rotational movement of the protective hood, with respect to the machine housing, in both directions of rotation of the circumferential direction around the output axis. The rotational movement may comprise a clockwise or an anti-clockwise direction of rotation.

The securing element is designed to tension the machine housing, in particular the flange neck, in an axial direction with respect to the protective hood, in particular the protective hood collar, in a connection state.

The protective device may have a first connection state, in which the protective hood is held by positive engagement the machine housing, in the axial direction of the output shaft. In this case, in particular, a rotational movement of the protective hood with respect to the machine housing is to be made possible, in that the protective hood is mounted rotatably with the machine housing.

The protective device may have a second connection state, in which the securing element holds the protective hood on the machine housing in the axial direction of the output axis and, in particular, tensions it with respect to the machine housing.

A connection state is to be understood to mean, in particular, a state of the protective device, in particular the hand-held power tools, in which the machine housing, in particular the flange neck, is connected to the protective hood and preferably to the securing element.

An “output shaft” in this context is to be understood to mean, in particular, a mechanical shaft that is designed to be directly or indirectly driven by a drive unit, in particular by a motor unit. Preferably, it is to be understood to mean, in particular, a shaft that is connected to a tool receiver, or directly forms a tool receiver that, preferably, receives an insert tool. In particular, the shaft, in particular the axis, on which the insert tool can be fastened, may protrude approximately from the centre of the machine housing, in particular the flange neck, of the hand-held power tool, and project beyond the machine housing, in particular the flange neck. In particular, the region of the protective hood that, at least in sections, completely encompasses the machine housing in a rotationally settable manner is referred to as a protective-hood connecting piece or collar, and can preferably be fixed in a lockable manner to the machine housing, in particular the flange neck.

The terms “output axis” and “tool rotation axis” denote notional, geometric rotational axes of the hand-held power tool, or of the insert tool.

The insert tool is realized, in particular, as a grinding or cutting disk.

It is understood that any elements mentioned in this application may also be present in a plurality.

The dependent claims specify expedient developments the protective device according to the invention.

It may be expedient for the machine housing, in particular the flange neck, to have a tooth geometry, in particular a tooth profile, that extends in the axial direction of the output axis. The tooth geometry may have a plurality of tapers that extend in the axial direction of the output axis. In particular, the tooth geometry, in particular its tapers, may extend, in the axial direction of the output axis, in a direction toward the machine housing. Preferably, the tooth geometry may have a plurality of teeth. A particularly reliable rotationally fixed connection between the tooth geometry and the securing element can thereby be achieved.

It may also be expedient for the machine housing, in particular the flange neck, to have a radial material recess that extends in the circumferential direction around the output axis. The material recess may be delimited, in the axial direction of the output axis, by the tooth geometry. The material recess may be open outwardly in the radial direction of the output axis. The material recess may reduce a cross section of the machine housing. The material recess may be realized, in particular, as a continuous groove around the machine housing. The material recess may extend in a plane, in particular a radial plane, around 360°. This makes it possible to achieve a particularly simple and space-saving connection of the protective hood to the machine housing.

Furthermore, it may be expedient for the protective hood to have a protective hood collar comprising a thread, in particular an external thread, for screw connection to the securing element. Preferably, the thread may be arranged in an outer region of the protective hood, in particular of the protective hood collar. The thread may preferably surround the protective hood collar. The protective hood may form a screw connection by means of the securing element. In particular, the thread may be continuous around the output axis. This makes it possible to achieve a reliable connection of the protective hood with respect to the machine housing.

Furthermore, it may be expedient for the protective hood to have an engagement element that is designed, in a connection state, to connect the protective hood in a rotationally fixed manner, by positive and/or non-positive engagement, to the machine housing, in particular to the flange neck, preferably to the tooth profile. The engagement element may be designed to limit a rotational movement of the machine housing with respect to the protective hood. A particularly compact protective device can thereby be achieved.

It is proposed that the engagement element be realized as an engagement protuberance that extends in the radial direction of the output axis and that is arranged on an inner region of the protective hood, in particular of the protective hood collar. The engagement element may protrude radially in a direction toward the output axis. The engagement element may delimit a minimum radial extent of the protective hood, in particular of the protective hood collar, in the radial direction of the output axis. The engagement element may be realized as an engagement bolt, or an engagement pin. The engagement element may be integral with the protective hood. The tooth geometry may be designed to receive the engagement element by positive engagement in the circumferential direction around the output axis and, in at least one operating state, to form a means for locking the protective hood against rotation with respect to the machine housing. The engagement element may be tensioned against the tooth geometry, in the axial direction of the output axis, in at least one operating state. The machine recess is designed to receive the engagement element.

In the connection state, the engagement may be arranged in the material recess.

In the first connection state, the engagement element may be arranged in the material recess, and mounted so as to be rotatable with respect to the machine housing.

In the second connection state, the engagement element may be in engagement with the tooth geometry, or be tensioned with respect to the tooth geometry. In this case, in the second connection state, the securing element can be unscrewed from the protective hood, as a result of which it contacts, for example, a radially projecting part of the machine housing and tensions the protective hood with respect to the machine housing. Thus, in particular, a rotational movement of the protective hood with respect to the machine housing is to be blocked, in that the engagement element is in engagement with the tooth geometry, or is tensioned with respect to the tooth geometry.

“Integral” is to be understood to mean, in particular, connected at least in a materially bonded manner, for example by a welding process, an adhesive process, an injection process, a stamping procedure, a laser cutting procedure, and/or another process considered appropriate by persons skilled in the art, and/or, advantageously, formed in one piece such as, for example, by being produced from a casting and/or by being produced in a single or multi-component injection process and, advantageously, from a single blank.

It is also proposed that the securing element, in particular the securing ring, in a connection state, be screwed in such a manner that the securing element moves the protective hood, in the axial direction of the output axis, with respect to the machine housing, and presses, and in particular tensions, the engagement element against the tooth profile. The protective device can thereby be realized in a particularly simple manner.

It is further proposed that the machine housing, in particular the flange neck, have an axial guide groove that is designed to guide the protective hood, in particular the engagement element, in the axial direction through the machine housing, in particular the flange neck. The guide groove may be realized as a guide channel for guiding the engagement element. The guide groove may be delimited in the axial direction by the tooth geometry, or by the material recess and by the axial extent of the machine housing, in particular of the flange neck. The tooth geometry may delimit the guide groove in the circumferential direction around the output axis. In the circumferential direction around the output axis, the guide groove may form a region without tooth geometry, along which the engagement element can be guided. This enables the engagement element to be guided into the material recess, and secured on the machine housing, in a particularly simple manner.

It may be expedient for the protective hood collar in a connection state to be arranged, in the radial direction of the output axis, between the securing element, in particular the securing ring, and the machine housing, in particular the flange neck. The securing element can thereby protect the protective hood collar, in particular the thread, against damage during operation.

It may also be expedient for the securing element, in particular the securing ring, to surround the protective hood, in particular the protective hood collar, at least in sections, and the machine housing, in particular the flange neck, at least in sections, in a plane, in particular a radial plane, of 360°. This enables an operator to conveniently actuate, or rotate, the securing element.

The invention also relates to a hand-held power tool having a machine housing, or a protective device according to the invention.

The invention further relates to a grinding system, comprising an angle grinder that has a protective device, and comprising a grinding or cutting disk for driving by means of the angle grinder.

### BRIEF DESCRIPTION OF THE DRAWINGS

Further advantages are disclosed by the following description of the drawing. The drawings shows exemplary embodiments of the invention. The drawings, the description and the claims contain numerous features in combination. Persons skilled in the art will also expediently consider the features individually and combine them to create appropriate further combinations. There are shown:

FIG. 1 a view of an exemplary hand-held power tool from the prior art,

FIG. 2 a view of the transmission of the hand-held power tool from FIG. 1,

FIG. 3 a view of a first embodiment of a protective device according to the invention,

FIG. 4 a view of a part of the protective device of FIG. 3,

FIG. 5 a view of a part of the protective device of FIG. 3, and

FIG. 6 a view of a part of the protective device of FIG. 3.

In the following figures, components that are the same are denoted by the same reference numerals.

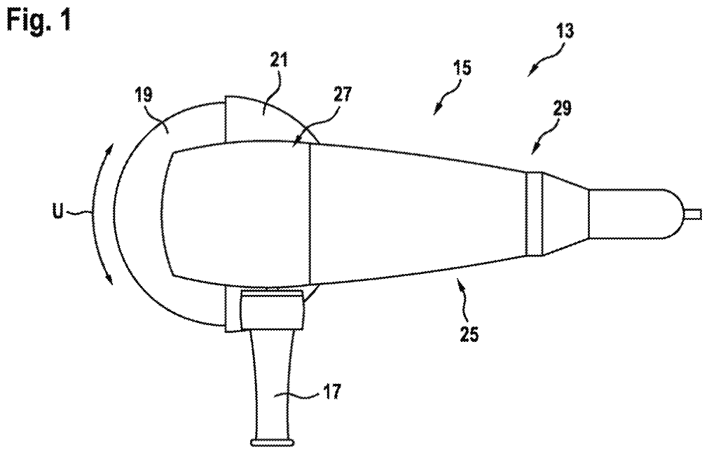

FIG. 1 shows a hand-held power tool 13, realized as an angle grinder 13, having a housing 15, having an ancillary handle 17 arranged on the housing 15, having a cutting disk 19, and having a protective hood 21 that, at least in sections, surrounds the cutting disk 19.

The cutting disk 19 is designed for cutting and/or grinding workpieces. The cutting disk 19 can be used universally and in particular is suitable for performing work on cellulose workpieces such as, for example, grass, scrub or roots, wood, plastic or a composite. Alternatively, however, the cutting disk 19 may also be used for performing work on, for example, metal, stone or a composite.

The protective hood 21 is designed to be detachably received on standard rotationally driven angle grinders 13. The protective hood 21 may be received in a receiving device 23 of a hand-held power tool, already known to persons skilled in the art and designed to receive the protective hood 21, having a rotatory and/or translational movement onto to a workpiece on which work is to be performed.

A suitable power tool is a non-stationary hand-held power tool such as, for example, an angle grinder 13 or a hand-held circular saw according to the application DE 3740200 A1 or such as, for example, a backpack-type brushcutter according to the application DE 19616764 A1.

The housing 15 is realized as a machine housing 25, and comprises a transmission housing 27 that surrounds a transmission (not represented), in particular a bevel-gear transmission, and at least one handle housing 29 that, at least in sections, receives, or at least surrounds, a drive unit (not represented). The protective hood 21 is intended, expediently, to cover at least or up to 180° of the cutting disk, in order to protect the operator of the angle grinder 13 against flying sparks.

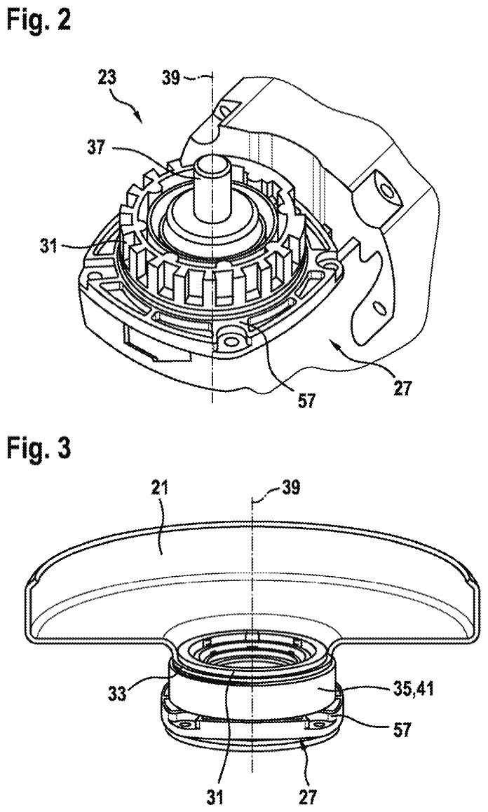

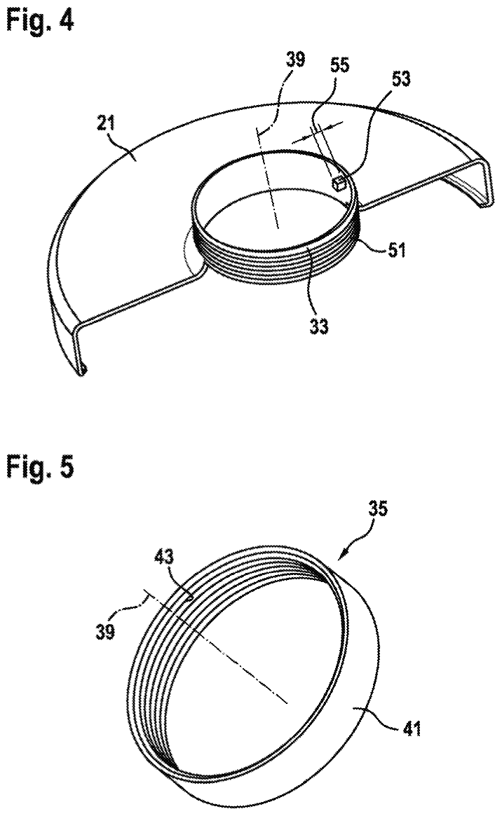

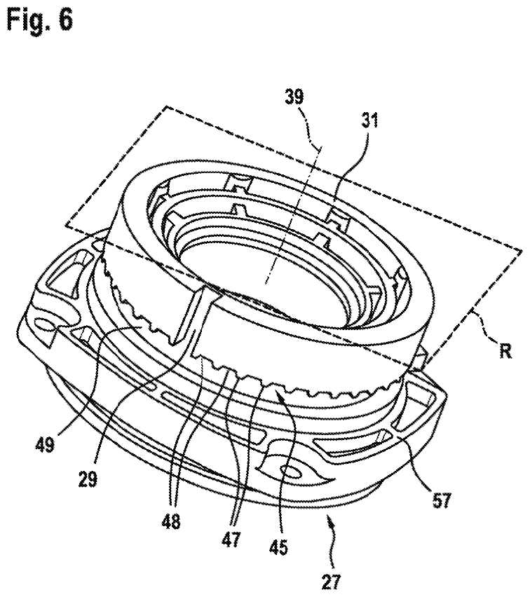

FIG. 2 shows a part of a conventional protective device from the prior art. The protective device is realized on the transmission housing 27, which is connected to the handle housing 29.

FIG. 3 shows a protective device according to the invention for an angle grinder 13, comprising a machine housing 25, which has a transmission housing 27 that has a flange neck 31, comprising a protective hood 21 that has a protective hood collar 33, and comprising a securing element 35 that is designed, in at least one operating state, to form a means for locking the protective hood 21 against rotation with respect to the machine housing 27. The transmission housing 27 is realized such that it can be detachably connected to the protective hood 21 and to the securing element 35. The flange neck 31 surrounds an output shaft 37, which has an output axis 39. The output shaft 37 projects with respect to the flange neck 31. The output shaft 37 directly forms a tool receiver that is designed to receive an insert tool 19. In an alternative embodiment, the tool receiver 23 may be realized from a tool receiving device according to the application DE 20 2013 006 900 L1 or DE 20 2013 006 901 U1. The output shaft 37 protrudes approximately from the centre of flange neck. 31, and projects beyond the flange neck 31.

The securing element 35 is realized as a securing ring 41.

The angle grinder 13 can be connected to the insert tool 19 that is coupled so as to be rotatably movable about the output axis 39. The insert tool 19 is realized as a cutting disk 19 or as a grinding disk. The insert tool 19 in this case may have a tool axis. The insert tool 19 may be detachably connected to the output shaft 37 in such a manner that, in particular, the tool axis and the output axis 39 substantially coincide.

The protective hood collar 33 is realized as a hollow cylinder, and extends in the axial direction of the output axis 39. The protective hood collar 33 delimits the protective hood 21 in an axial direction of the output axis 39 toward the transmission housing 27. The protective hood collar 33 and the securing ring 41 can be detachably connected to the hand-held power tool, and can thus also be separated from the hand-held power tool if necessary, for example in order pack or compactly store the latter. In an alternative embodiment, the securing element 35 may be integrally connected to the flange neck 31 or the to the protective hood collar 33. The protective hood collar 33 encompasses the flange neck 31 completely and in a rotationally settable manner, and can be locked on it.

The protective hood 21 is adjustable, in the circumferential direction U around the output axis 39, relative to the transmission housing 27. The protective hood 21 has an adjustment capability, in the circumferential direction U around the output axis 39, that is independent of direction, whereby the protective hood collar 33 locks by positive engagement in a direction of rotation of the circumferential direction U.

The protective hood 21 is intended, expediently, to cover at least or up to 180° of a cutting or grinding disk, and in order to protect the operator of the hand-held power tool against flying sparks. Depending on the use of the hand-held power tool, it is necessary to adjust the protective hood 21 and accordingly bring it into different positions in order to cover typical application situations, such as left/right-handed users, cutting or grinding, profile of the material on which work is to be performed.

The securing element 35, realized as a securing ring 41, has an internal thread 43. The securing ring 41 is designed, in at least one connection state, to mount and hold the protective hood 21 such that it is movable, with respect to the flange neck 31, in the axial direction of the output axis 39. The securing ring 41 limits a movement of the flange neck 31 in the axial direction of the output axis. The securing ring 41, in a connection state in which it is connected to the protective hood 21, is preloaded in the axial direction.

The thread of the securing ring 41 is continuous around the output axis 39. The internal thread 43 of the securing ring 41 forms screw connection with the protective hood collar 33.

The flange neck 31 has a tooth geometry 45 that forms a tooth profile 45. The tooth profile 45 extends in the axial direction of the output axis 39. The tooth profile 45 has a plurality of tapers 47 that extend in the axial direction of the output axis 39. Realized between the tapers 47 are depressions 48 that are designed to receive a part of the protective hood collar 33, in order to form a means for locking the protective hood 21 against rotation with respect to the flange neck 31, in the circumferential direction U around the output axis 39. The tapers 47 extend, in the axial direction of the output axis 39, in a direction toward the transmission housing 27. The tooth profile 45 has a plurality of teeth.

The flange neck 31 also has a radial material recess 49 that extends in the circumferential direction U around the output axis 39. The material recess 49 delimits the tooth profile 45 in the axial direction of the output axis 39. The material recess 49 is open outwardly in the radial direction of the output axis 39. The material recess 49 reduces a cross section of the machine housing 25. The material recess 49 is realized as a continuous groove around the machine housing 25. The material recess 49 extends in a radial plane R, around 360° C.

The protective hood collar 33 has a thread 51, realized as an external thread, for screw connection to the securing ring 41. The external thread 51 is arranged in an outer region of the protective hood collar 33. The external thread 51 completely surrounds the protective hood collar 33. The external thread 51 extends around the protective hood collar 33.

The protective hood collar 33 has an engagement element 53 that is designed to connect, and in a connection state to connect in a rotationally fixed manner, by positive and/or non-positive engagement, the protective hood 21 to the flange neck 31, or to the tooth profile 45. The engagement element 53 is designed to limit a rotational movement of the machine housing 25 with respect to the protective hood 21. The engagement element 53 in this case engages between the tapers 47 of the tooth profile 45, or in the depressions 48 of the tooth profile 45.

The engagement element 53 is realized as an engagement protuberance 55, extending in the radial direction of the output axis 39, that is arranged on an inner region of the protective hood collar 33. The engagement element 53 protrudes radially in a direction toward the output axis 39. The engagement element 53 delimits a minimum radial extent of the protective hood collar 33 in the radial direction of the output axis 39. The engagement element is realized as an engagement bolt, or an engagement pin. The engagement element 53 is integral with the protective hood 21. The tooth profile 45 is designed to receive the engagement element 53 by positive engagement in the circumferential direction U around the output axis 39 and, in at least one operating state, to form a means for locking the protective hood 21 against rotation with respect to the flange neck 31. The engagement element 53 is tensioned against the tooth geometry 45, in the axial direction of the output axis 39, in at least one operating state. The machine recess is designed to receive the engagement element 53.

The protective device may have at least two connection states, in which the engagement element 53 of the protective hood collar 33 is arranged in the material recess 49. In a first connection state, the protective hood collar 33 is secured by positive engagement, in the axial direction of the output axis 39, against being unintentionally detached in the axial direction, and is held on the flange neck 31. The protective hood collar 33 in this case is mounted in a rotatable manner with respect to the flange neck 31, in that the engagement element 53 is mounted so as to be movable in the material recess 49, in the circumferential direction U around the output axis 39.

In the second connection state, the securing ring 41 is screwed in such a manner that the securing ring 41 moves the protective hood collar 33, in the axial direction of the output axis 39, with respect to the transmission housing 27, and presses and tensions the engagement element 53 against the tooth profile 45.

In the second connection state, in which the securing element 35 holds the protective hood 21 on the transmission housing 27, in the axial direction of the output axis, and tensions it with respect to the transmission housing, the protective hood collar 33 is mounted so as to be non-rotatable about the output axis 39, in the circumferential direction U, and forms the rotation lock.

In the second connection state, the engagement element 53 is in engagement with the tooth profile 45, and is tensioned with respect to the tooth profile 45. In this case, in the second connection state, the securing ring 41 is unscrewed from the protective hood 21, as a result of which it contacts a radial region 57 of the transmission housing 27 and tensions the protective hood collar 33 with respect to the flange neck 31. The radial region 57 of the transmission housing 27 delimits the transmission housing in the radial direction of the output axis 39. The radial region 57 is realized as a radial shoulder. A rotational movement of the protective hood collar 33 with respect to the transmission housing 27 is thereby blocked by positive engagement, in that, the engagement element 53 is in engagement with the tooth profile 45.

The flange neck 31 has an axial guide groove 59 that is designed to guide the engagement element 53 in the axial direction through the flange neck 31. The guide groove is realized as a guide channel for guiding the engagement element 53. The guide groove 59 is delimited in the axial direction by the tooth geometry 45, or by the material recess 49, and by the axial extent of the flange neck 31. In the axial direction of the output axis 39 the guide groove 59 leads into the material recess 49. The tooth profile 45 delimits the guide groove 59 in the circumferential direction U around the output axis 39. In the circumferential direction U around the output axis 39, the guide groove 59 forms a region without tooth geometry, along which the engagement element 53 can be guided.

In a connection state, the protective hood collar 33 is arranged, in the radial direction of the output axis 39, between the securing ring 41 and the flange neck 31.

The securing ring 41 surrounds the protective hood collar 33, at least in sections, and the flange neck 31, at least in sections, in a radial plane of 360°.

1. A protective device for a hand-held power tool, comprising:
a machine housing having a flange neck that surrounds an output shaft, the output shaft defining an output axis;
a protective hood having a protective hood collar; and
a securing element configured as a securing ring, the securing ring configured, in at least one operating state, to lock the protective hood against rotation with respect to the machine housing,
wherein the machine housing is configured to be detachably connected to one or more of the protective hood and the securing element, and
wherein the securing ring has a thread that is configured, in at least one connection state, to mount the protective hood such that the protective hood is movable, with respect to the flange neck, in an axial direction of the output axis.

2. The protective device as claimed in claim 1, wherein the machine housing has a tooth geometry that extends in the axial direction of the output axis.

3. The protective device as claimed in claim 1, wherein the machine housing has a radial material recess that extends in a circumferential direction around the output axis.

4. The protective device as claimed in claim 1, wherein the protective hood collar includes a thread configured for screw connection to the securing element.

5. The protective device as claimed in claim 1, wherein the protective hood has an engagement element that is configured, in a connection state, to connect the protective hood in a rotationally fixed manner, by one or more of positive and non-positive engagement, to the machine housing.

6. The protective device as claimed in claim 5, wherein the engagement element is configured as an engagement protuberance that extends in a radial direction of the output axis and that is arranged on an inner region of the protective hood collar.

7. The protective device as claimed in claim 5, wherein the securing ring, in a connection state, is screwed such that the securing element moves the protective hood, in the axial direction of the output axis, with respect to the machine housing, and presses the engagement element against a tooth profile.

8. The protective device as claimed in claim 5, wherein the machine housing has an axial guide groove that is configured to guide the protective hood in the axial direction through the machine housing.

9. The protective device as claimed in claim 1, wherein the protective hood collar in a connection state is arranged, in a radial direction of the output axis, between the securing ring and the machine housing.

10. The protective device as claimed in claim 1, wherein the securing ring surrounds the protective hood collar, at least in sections, and the machine housing, at least in sections, in a plane of 360°.

11. The protective device as claimed in claim 1, wherein the hand-held power tool is configured as an angle grinder, and wherein the thread of the securing ring is an internal thread.

12. The protective device as claimed in claim 2, wherein the flange neck has the tooth geometry, and wherein the tooth geometry is configured as a tooth profile that extends in the axial direction of the output axis.

13. The protective device as claimed in claim 3, wherein the flange neck has the radial material recess.

14. The protective device as claimed in claim 4, wherein the thread of the protective hood collar is an external thread.

15. The protective device as claimed in claim 5, wherein the engagement element is configured, in the connection state, to connect the protective hood in the rotationally fixed manner to a tooth profile of the flange neck.

16. The protective device as claimed in claim 7, wherein securing element, in the connection state, tensions the engagement element against the tooth profile.

17. The protective device as claimed in claim 8, wherein the flange neck has the axial groove, and wherein the axial groove is configured to guide the engagement element in the axial direction through the flange neck.

18. The protective device as claimed in claim 9, wherein the protective hood collar in the connection state is arranged, in the radial direction of the output axis, between the securing ring and the flange neck.

19. The protective device as claimed in claim 10, wherein the securing ring surrounds the protective hood collar and the flange neck in a radial plane of 360°.
